(19) United States
(12) Patent Application Publication
(10) Pub. No.: US 2024/0020915 A1
(43) Pub. Date: Jan. 18, 2024

(54) GENERATIVE MODEL FOR 3D FACE SYNTHESIS WITH HDRI RELIGHTING

(71) Applicant: Google LLC, Mountain View, CA (US)

(72) Inventors: Yinda Zhang, Daly City, CA (US); Feitong Tan, Beijing (CN); Sean Ryan Francesco Fanello, San Francisco, CA (US); Abhimitra Meka, San Francisco, CA (US); Sergio Orts Escolano, San Francisco, CA (US); Danhang Tang, West Hollywood, CA (US); Rohit Kumar Pandey, Sunnyvale, CA (US); Jonathan James Taylor, San Francisco, CA (US)

(21) Appl. No.: 18/353,213

(22) Filed: Jul. 17, 2023

Related U.S. Application Data
(60) Provisional application No. 63/368,555, filed on Jul. 15, 2022.

(51) Int. Cl. G06T 15/80; G06T 15/08

(52) U.S. Cl. CPC G06T 15/80; G06T 15/08

(57) ABSTRACT

Techniques include introducing a neural generator configured to produce novel faces that can be rendered at free camera viewpoints (e.g., at any angle with respect to the camera) and relit under an arbitrary high dynamic range (HDR) light map. A neural implicit intrinsic field takes a randomly sampled latent vector as input and produces as output per-point albedo, volume density, and reflectance properties for any queried 3D location. These outputs are aggregated via a volumetric rendering to produce low resolution albedo, diffuse shading, specular shading, and neural feature maps. The low resolution maps are then upsampled to produce high resolution maps and input into a neural renderer to produce relit images.

### CROSS REFERENCE TO RELATED APPLICATION

This application claims priority to U.S. Provisional Application No. 63/368,555, filed on Jul. 15, 2022, entitled “GENERATIVE MODEL FOR 3D FACE SYNTHESIS WITH HDRI RELIGHTING”, the disclosure of which is incorporated by reference herein in its entirety.

### TECHNICAL FIELD

This description relates in general to high dynamic range illumination (HDRI) relighting.

### BACKGROUND

Digital relighting applications take in any number of human faces for various applications, e.g., teleportation, augmented reality meetings, portrait manipulation, and virtual try-on. For example, a portrait where the human face is at an angle with respect to the camera can be reshown, through a machine learning model, at any other angle. The portrait may be digitally relit to take into account the change in lighting perspective.

### SUMMARY

The implementations described herein include a generative framework to synthesize 3D-aware faces with convincing relighting (can be referred to as VoLux-GAN). In some implementations, a volumetric HDRI relighting method, as disclosed herein, can efficiently accumulate albedo, diffuse and specular lighting contributions along each 3D ray for any desired HDR environmental map. Additionally, some implementations illustrate the importance of supervising the image decomposition process using multiple discriminators. In particular, some implementations include a data augmentation technique that leverages recent advances in single image portrait relighting to enforce consistent geometry, albedo, diffuse and specular components. The implementations described herein illustrate how the model is a step forward towards photorealistic relightable 3D generative models.

In one general aspect, a method includes generating a random latent vector representing an avatar of a synthetic human face. The method also includes determining low-resolution maps of albedo, diffuse shading, and specular shading, and a low-resolution feature map based on the random latent vector and a high dynamic range illumination (HDRI) map. The method further includes producing high-resolution maps of albedo, diffuse shading, and specular shading by performing an upsampling operation on the low-resolution maps of albedo, diffuse shading, and specular shading and the low-resolution feature map. The method further includes providing a lighting of the synthetic human face based on the high-resolution maps of albedo, diffuse shading, and specular shading to produce a lit image of the synthetic human face.

In another general aspect, a computer program product comprising a nontransitory storage medium, the computer program product including code that, when executed by at least one processor, causes the at least one processor to perform a method. The method includes generating a random latent vector representing an avatar of a synthetic human face. The method also includes determining low-resolution maps of albedo, diffuse shading, and specular shading, and a low-resolution feature map based on the random latent vector and a high dynamic range illumination (HDRI) map. The method further includes producing high-resolution maps of albedo, diffuse shading, and specular shading by performing an upsampling operation on the low-resolution maps of albedo, diffuse shading, and specular shading and the low-resolution feature map. The method further includes providing a lighting of the synthetic human face based on the high-resolution maps of albedo, diffuse shading, and specular shading to produce a lit image of the synthetic human face.

In another general aspect, an apparatus includes memory and processing circuitry coupled to the memory. The processing circuitry is configured to generate a random latent vector representing an avatar of a synthetic human face. The processing circuitry is also configured to determine low-resolution maps of albedo, diffuse shading, and specular shading, and a low-resolution feature map based on the random latent vector and a high dynamic range illumination (HDRI) map. The processing circuitry is further configured to produce high-resolution maps of albedo, diffuse shading, and specular shading by performing an upsampling operation on the low-resolution maps of albedo, diffuse shading, and specular shading and the low-resolution feature map. The processing circuitry is further configured to provide a lighting of the synthetic human face based on the high-resolution maps of albedo, diffuse shading, and specular shading to produce a lit image of the synthetic human face.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example Volux-GAN framework for generating relit images of synthetic human faces.

FIG. 2 is a diagram that illustrates an example Volux-GAN architecture used in the Volux-GAN framework.

FIG. 3 is a diagram that illustrates an example electronic environment for performing the improved techniques described herein.

FIG. 4 is a flow chart that illustrates an example method of performing the image lighting according to the improved techniques described herein.

### DETAILED DESCRIPTION

Digital relighting applications take in any number of human faces for various applications, e.g., teleportation, augmented reality meetings, portrait manipulation, and virtual try-on. For example, a portrait where the human face is at an angle with respect to the camera can be reshown, through a machine learning model, at any other angle. The portrait may be digitally relit to take into account the change in lighting perspective.

A technical problem with such relighting applications is that training such a model requires the use of a large set of human faces that are digitally rendered at various angles with respect to the camera. Using such a large set of human faces involves personally identifiable information (PII) and accordingly complex permission management.

A technical solution to some or all of the above technical problems includes introducing a neural generator configured to produce novel faces that can be rendered at free camera viewpoints (e.g., at any angle with respect to the camera) and relit under an arbitrary high dynamic range (HDR) light map. A neural implicit intrinsic field takes a randomly sampled latent vector as input and produces as output per-point albedo, volume density, and reflectance properties for any queried 3D location. These outputs are aggregated via a volumetric rendering to produce low resolution albedo, diffuse shading, specular shading, and neural feature maps. The low resolution maps are then upsampled to produce high resolution maps and input into a neural renderer to produce relit images.

Generating synthetic novel human subjects with convincing photorealism is one of the most desired capabilities for automatic content generation and pseudo ground truth synthesis for machine learning. Such data generation engines can thus benefit many areas including the gaming and movie industries, telepresence in mixed reality, and computational photography.

The implementations described herein are related to a neural human portrait generator, which deliver compelling rendering quality on arbitrary camera viewpoints and under any desired illumination. The implementations described herein include a 3D aware generative model with HDRI relighting supervised by adversarial losses. To overcome the limitations of other methods, the implementations described herein include at least two features, as follows.

Volumetric HDRI Relighting. Some implementations include a novel approach of the volumetric rendering function that naturally supports efficient HDRI relighting. At least one aspect relies on the intuition that diffuse and specular components can be efficiently accumulated per-pixel when pre-filtered HDR lighting environments are used. This can be applied to single image portrait relighting, and in this implementation, we introduce an alternative formulation to allow for volumetric HDRI relighting. Different from other implementations that predict surface normal and calculate the shading with respect to the light sources (for a given HDR environment map), the implementations described herein directly integrate the diffuse and specular components at each 3D location along the ray according to their local surface normal and viewpoint direction. In some implementations, simultaneously, an albedo image and neural features are accumulated along the 3D ray. In some implementations, a neural renderer combines the generated outputs to infer the final image.

Supervised Image Decomposition. Though producing impressive rendering quality, the geometry from 3D-aware generators is often incomplete or inaccurate. As a result, the model tends to bias the image quality for highly sampled camera views (e.g., front facing), but starts to show unsatisfactory multi-view consistency and 3D perception, breaking the photorealism when rendered from free-viewpoint camera trajectories. In some implementations, high quality geometry is particularly important for relighting since any underlying reflectance models rely on accurate surface normal directions in order to correctly accumulate the light contributions from the HDR environment map.

Similarly, decomposing an image into albedo, diffuse and specular components without explicit supervision could lead to artifacts and inconsistencies, since, without any explicit constrains, the network could encode details in any channel even though it does not follow light transport principles.

The implementations described herein include a data augmentation technique to explicitly supervise the image decomposition in geometry, albedo, diffuse and specular components. The implementations described herein employ techniques to generate albedo, geometry, diffuse, specular and relit images for each image of the dataset, and have additional discriminators guide the intrinsic decomposition during the training. This technique alone, however, would guide the generative model to synthesize images that are less photorealistic since their quality upper bound would depend on the specific image decomposition and relighting algorithm used as supervision. In order to address this, the implementations described herein also add a final discriminator on the original images, which can guide the network towards real photorealism and higher order light transport effects such as specular highlights and subsurface scattering.

A technical advantage of the above-described technical solution is that it can generate synthetic, novel human subjects with convincing photorealism, which eliminates the need for complex permission management. Moreover, at least some features in the implementations described herein include: 1) a novel approach to generate HDRI relightable 3D faces with a volumetric rendering framework; 2) supervised adversary losses are leveraged to increase the geometry and relighting quality, which also improves multi-view consistency; and 3) examples that demonstrate the effectiveness of the framework for image synthesis and relighting.

The implementations described herein include a volumetric generative model that supports full HDR relighting. The implementations can efficiently aggregate albedo, diffuse and specular components within the 3D volume. Due to the explicit supervision in adversarial losses, the implementations described herein demonstrate that the method can perform such a full image component decomposition for novel face identities, starting from a randomly sampled latent code.

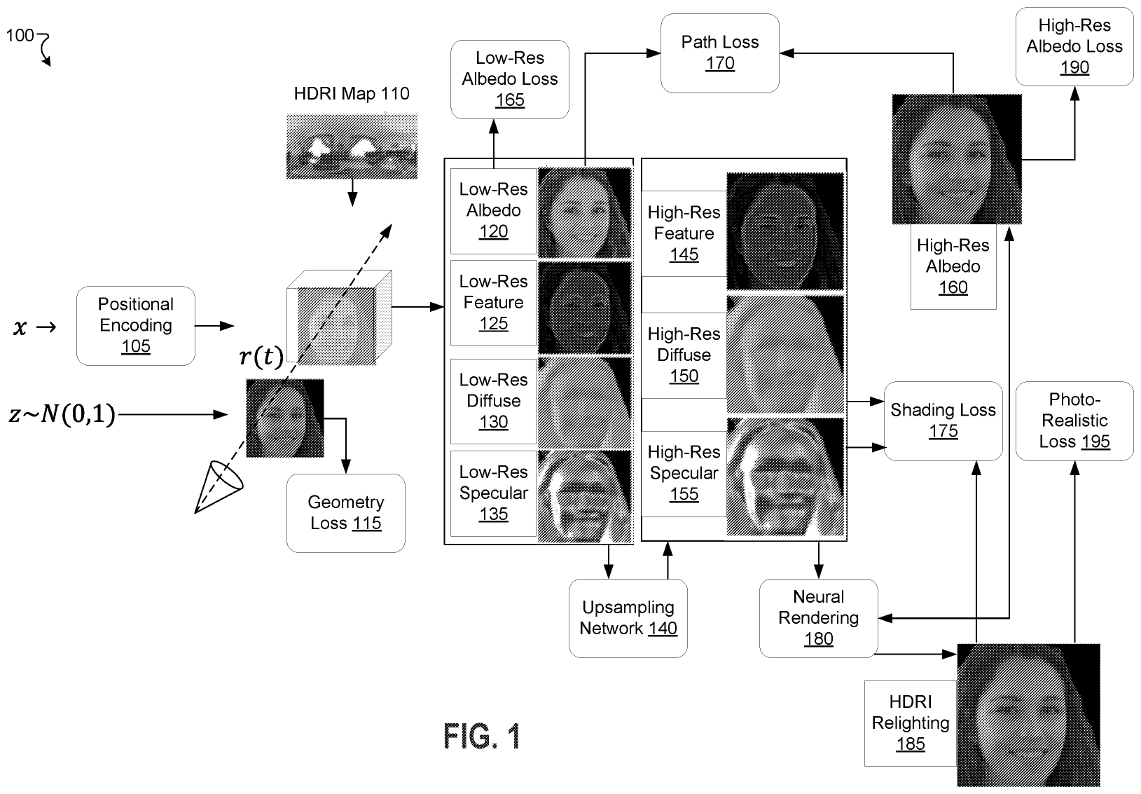

Some implementations start from a neural implicit field that takes a randomly sampled latent vector as input and produces an albedo, volume density, and reflectance properties for queried 3D locations. These outputs can then be aggregated via volumetric rendering to produce low resolution albedo, diffuse shading, specular shading, and neural feature maps. These intermediate outputs can then be upsampled to high resolution and fed into a neural renderer to produce relit images. An overall framework example is depicted in FIG. 1.

Some implementations are based on a neural volumetric rendering framework. In some implementations, the 3D appearance of an object of interest is encoded into a neural implicit field implemented using a multilayer perceptron (MLP), which takes a 3D coordinate x∈ [symbol] ³ and viewing direction d∈S² as inputs and outputs a volume density σ∈ [symbol] ⁺ and view-dependent color c∈ [symbol] ³. To render an image, the pixel color C is accumulated along each camera ray r(t)=o+t d as

C(r,d)=∫ₜ_{ₙ}^{t}^{_{f}}T(t)σ(r(t))c(r(t),d)dt (1)
where T(t)=exp [−∫ₜ_{ₙ}σ(r(s))ds] and bounds tₙ and t_{f}. Compared to surface based rendering, volumetric rendering more naturally handles translucent materials and regions with complex geometry such as thin structures.

At least some implementations train an MLP-based neural implicit field conditioned on a latent code z sampled from a Gaussian distribution N(0,1)^{d} and extend it to support HDRI relighting. In some implementations, the illumination of each point is determined by albedo, diffuse, and specular component. Therefore, instead of having the network predict per-point radiance and directly obtaining a color image (via Eq. (1)), the network described herein produces per-point albedo (a), density (a) and reflectance properties from separate MLP heads. The normal directions are obtained via the spatial derivative of the density field, which are used together with HDR illumination to compute diffuse and specular shading. Rather than explicitly using the Phong model for the final rendering, some implementations feed the albedo, diffuse and specular components to a lightweight neural renderer, which can also model higher order light transport effects.

Some implementations assume Lambertian shading from a single light source. Extending this to support full HDR illumination could require the integration of the shading contribution from multiple positional lights, making the approach computationally prohibitive, especially when performed at training time for millions of images. Some implementations adopt a method designed for real-time shading rendering under HDR illumination. Some implementations can approximate the diffuse and specular components using a preconvolved HDRI map. Specifically, implementations include first preconvolve the given HDRI map (H) into light maps (Lₙ_{ᵢ}, i=1, 2, . . . , N) with cosine lobe functions corresponding to a set of pre-selected Phong specular exponents (nᵢ, i=1, 2, . . . , N). In some implementations, the diffuse shading D is the first light map (i.e., n=1 above) following the surface normal direction, and the specular shading is defined as a linear combination of all light maps indexed by the reflection direction. To capture possible diverse material properties of the face, some implementations let the network estimate the blending weights (w)) with another MLP branch, which are then used for the specular component S.

The implementations described herein include a volumetric formulation to compute albedo, diffuse and view dependent specular shading maps as follows.

$$A ( r ) = {\int }_{{t}_{n}}^{{t}_{f}} T ( t ) σ ( r ( t ) ) α ( r ( t ) ) dt , \qquad ( 2 )$$

$$D ( r ) = {\int }_{{t}_{n}}^{{t}_{f}} T ( t ) σ ( r ( t ) ) {L}_{n = 1} ( n ( t ) ) dt ,$$

$$S ( r ) = {\int }_{{t}_{n}}^{{t}_{f}} T ( t ) σ ( r ( t ) ) {\sum }_{i}^{N} {ω}_{i} {L}_{{n}_{i}} ( n ( t ) , d ) dt ,$$

$$F ( r ) = {\int }_{{t}_{n}}^{{t}_{f}} T ( t ) σ ( r ( t ) ) f ( r ( t ) ) d t ,$$

where n(t) is the normal direction estimated via ∇σ(r(t)), Lₙ₌₁(n(t)) is the diffuse light map indexed by the normal direction n(t), and Lₙ_{ᵢ}(n(t), d) is the specular component ng indexed by the inbound reflection direction depending on the local normal and viewing direction d. Finally, α, σ, ω, and a per-location feature f are the network outputs conditioned on the sampled latent code z. Some implementations restrict the albedo to be view and lighting independent and encourage multi-view consistency. Note that in addition to rendering components such as albedo, diffuse and specular components, the network can accumulate additional features F(r), so that it can capture high frequency details and material properties in an unsupervised fashion.

Some implementations extend the architecture for the neural implicit field. Rather than explicitly use the low resolution albedo A(r) following Eq. (2), some network implementations produce a feature vector f(r(t))∈ [symbol] ²⁵⁶ via 6 fully-connected layers from the positional encoding on the 3D coordinates. In some implementations, a linear-layer is attached to the output of the 4-th layer to produce the volume density, and an additional two-layer MLP is attached to 6-th layer to produces the albedo and reflectance properties. In some implementations, diffuse component D and Specular Component S are estimated following Eq. (2), where the blending weights at are estimated by the network.

To reduce the memory consumption and computation cost, some implementations render albedo, diffuse, and specular shading in low resolution and upsample them to high resolution for relighting. The specific low and high resolutions depend on the dataset used. To generate the high resolution albedo, some implementations upsample the feature map F(r) and enforce its first 3 channels to correspond to the albedo image. In some implementations, at least some (e.g., each) upsampling unit consists of two 1×1 convolutions modulated by the latent code z, a pixelshuffle upsampler and a BlurPool with stride 1. The low resolution albedo A (r) can still be used to enforce consistency with the upsampled high resolution albedo (see Section 3.3). For shading maps, some implementations directly apply bilinear upsampling. In some implementations, a relighting network takes as input the albedo map A, the diffuse map D, the specular component map S and the features F and generates the final Iᵣₑₗᵢₜ image. In some implementations, the architecture of Relighting Network can be a shallow U-Net.

The following introduces at least one scheme to train a pipeline from a collection of unconstrained in-the-wild images. While it is possible to train the full pipeline with a single adversarial loss on the relit image, it can be empirically shown that adding additional supervision on intermediate outputs significantly improves the training convergence and rendering quality.

Pseudo Ground Truth Generation. Large scale in-the-wild images provide great data diversity, which is critical for training a generator. However, the groundtruth labels for geometry and shading are usually missing. Some implementations have “real examples” of the albedo and geometry to supervise the methods described herein. To this end, some implementations use a state-of-the-art image based relighting algorithm, to produce pseudo ground truth albedo and normals and to also further increase data diversity. Specifically, for each image in a training set, some implementations randomly select an HDRI map from a collection of maps sourced from public repository, apply a random rotation, and run a relighting algorithm to generate the albedo, surface normal and a relit image with the associated light maps (diffuse and specular components).

Albedo Adversarial Loss [symbol] _{A}: D_{A}(A(r))+D_{A}(Aₕᵢ₋ᵣₑₛ). In some implementations, the output albedo images in both low and high resolution with adversarial loss are supervised using a pseudo ground truth. In some implementations, a standard non-saturating logistic GAN loss with R1 penalty is applied to train the generator and discriminator (e.g., a discriminator architecture D_{*} for all the losses).

Geometry Adversarial Loss [symbol] _{G}: D_{G} (∇σ(r(t))). In some implementations, the geometry is supervised as it is crucial for multi-view consistent rendering and relighting realism. In some implementations, while the density σ is the immediate output from the network that measures the geometry, it can be more convenient to supervise the surface normals computed via ∇σ(r(t)). Therefore, an adversarial loss is added between the volumetric rendered normal from the derivative of the density and the pseudo ground truth normal.

Shading Adversarial Loss [symbol] _{S}: D_{S}(D(r),S(r),Iᵣₑₗᵢₜ). Directly supervising the albedo and relit pair with a reconstruction loss is not possible in some implementations. Indeed, the network produces new identity from a randomly sampled latent code where direct supervision is not available. Therefore, to enforce the relight network faithfully integrating shading with albedo, some implementations apply a conditional adversarial loss on the relit image. This is achieved by adding a discriminator D_{S} that takes the concatenation of the relit image Iᵣₑₗᵢₜ, diffuse map D(r) and specular map S(r) as the inputs and discriminate if the group is fake, i.e. from our model, or true. The training gradients may be allowed to back-propagate to the relit image but not the other inputs (i.e. set to zero) as they are the data to be conditioned on.

Photorealistic Adversarial Loss [symbol] _{P}: D_{DP}(Iᵣₑₗᵢₜ). A downside of the Shading Adversarial Loss is that the model performance is upper-bounded by the specific algorithm used to generate pseudogroundtruth labels. As a result, inaccuracies in the relighting examples, e.g. overly smoothed shading and lack of specular highlights, may affect our rendering quality. To enhance the photorealism, some implementations add an additional adversarial loss directly on the generated relit images with the original images from the dataset.

Path Loss path [symbol] ₚₐₜₕ: [symbol] ₁(A(r),Aₕᵢ₋ᵣₑₛ).). Some implementations add a loss to ensure the consistency between the albedo maps in low and high resolutions. Specifically, some implementations downsample the high resolution to the low resolution, and add a per-pixel [symbol] ₁ loss.

The final loss function can be a weighted sum of all above mentioned terms: [symbol] =λ₁ [symbol] _{A}+λ₂ [symbol] _{G}+λ₃ [symbol] _{S}+λ₄ [symbol] _{P}+λ₅ [symbol] ₚₐₜₕ, where for some examples these weights can be empirically determined to be 1.0, 0.5, 0.25, 0.75, 0.5.

FIG. 1 is a diagram that illustrates an example Volux-GAN framework 100 for generating relit images of synthetic human faces. As shown in FIG. 1, a random latent code (vector) z is sampled from a Gaussian distribution N(0,1) and is input into a mapping network to produce a style vector representing an avatar of a synthetic human face. Accordingly, the random latent vector represents the avatar of the synthetic human face.

An HDMI map 110 is used to define the illumination along various rays r(t) defined by the positional encoding 105. The HDMI is, in some implementations, preconvolved with cosine lobe functions corresponding to a set of pre-selected Phong specular exponents (ng, i=1, 2, . . . , N) to produce a set of light maps Lₙ_{ᵢ}, i=1, 2, . . . , N. The first of these light maps, Lₙ₌₁, is associated with a diffuse shading, while the other light maps are associated with a specular shading.

A 3D coordinate x∈ [symbol] ³ is encoded in a sinusoidal function based positional encoding 105 and input into a neural implicit intrinsic field (NIIF), which also receives the style vector. Based on sampling the synthetic human face using the rays, the NIIF determines per-point albedo (a), density (a) and reflectance properties from separate multilayer perceptron (MLP) heads of the NIIF. The geometry loss 115 is determined from the gradient of the density ∇σ(r(t)). Moreover, the NIIF determines a per-point feature vector f(r(t))∈ [symbol] ²⁵⁶ based on the style vector.

The NIIF performs a volumetric rendering of the per-point albedo, feature vector, and light maps as in Eqs. (2) to produce a low-resolution albedo 120, a low-resolution feature map 125, a low-resolution diffuse shading 130, and a low-resolution specular shading 135. The low-resolution albedo 120 determines a low-resolution albedo adversarial loss 165 and provides an input to determine path loss 170.

The low-resolution albedo 120, a low-resolution feature map 125, a low-resolution diffuse shading 130, and a low-resolution specular shading 135 are input into an upsampling network 140 to produce a high-resolution feature vector 145, a high-resolution diffuse shading 150, and a high-resolution specular shading 155. For example, if the low-resolution diffuse shading 130 is sampled on a 64×64 grid, then the high-resolution diffuse shading 150 is sampled on a 128×128 grid, or a 256×256 grid. The high-resolution diffuse shading 150 and the high-resolution specular shading 155 provide inputs for a shading adversarial loss 175.

The high-resolution feature vector 145, a high-resolution diffuse shading 150, and a high-resolution specular shading 155 are input into a neural rendering engine 180 to produce a high-resolution albedo 160. This is done by enforcing the first three channels of the high-resolution feature vector 145 to correspond to the albedo image. The low-resolution albedo 120 A(r) is used to enforce consistency with the high-resolution albedo 160. The high-resolution albedo loss 160 provides an input into the path loss 170 as well as the input for a high-resolution albedo loss 190.

The high-resolution feature vector 145, a high-resolution diffuse shading 150, and a high-resolution specular shading 155, and the high-resolution albedo 160 are input into the neural rendering engine 180 to produce a relit image 185, which is a 3D image of the synthetic human face at an arbitrary angle. The relit image 185 provides an input into the shading adversarial loss 175 and a photorealistic adversarial loss 195.

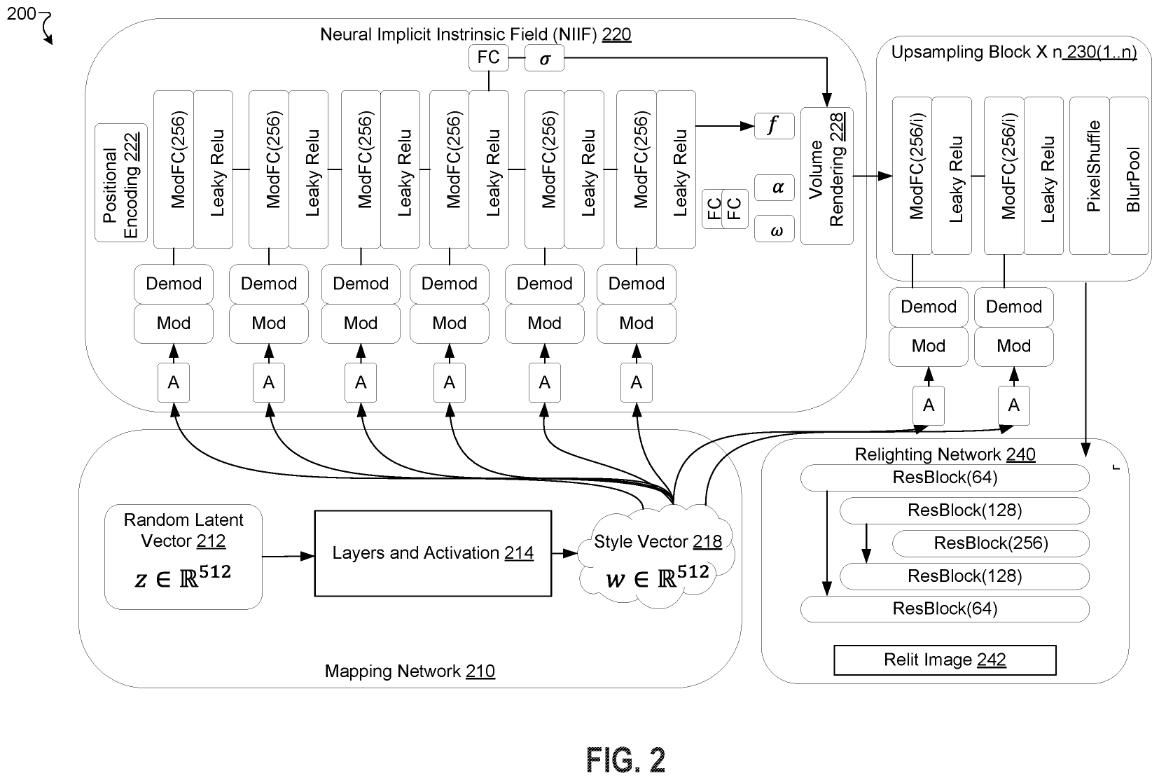

Processing circuitry forms a linear combination of the geometry adversarial loss ( [symbol] _{G}) 115, the low-resolution and high-resolution albedo adversarial losses ( [symbol] _{A}) 165 and 190, the shading adversarial loss ( [symbol] _{S}) 175, the photorealistic adversarial loss ( [symbol] _{P}) 195, and the path loss ( [symbol] ₚₐₜₕ) to form a loss function for training the Volux-GAN network that includes the mapping network, the NIIF, the upsampling network 140, and the neural rendering engine 180. The architecture of the Volux-GAN network is described in FIG. 2.

FIG. 2 is a diagram that illustrates an example Volux-GAN architecture 200 used in the Volux-GAN framework described in FIG. 1. In the Volux-GAN architecture 200, there are four modules: a mapping network 210, a NIIF 220, a set of upsampling blocks 230(1 . . . n), and a relighting network 240.

The mapping network 210 is configured to take as input a random latent vector 212, which is a 512-element vector of Gaussian samples, and produce a 512-element style vector 218 that represents a synthetic human face. The mapping network 210 includes layers and activation 214, which include eight fully-connected layers with 512 units each. The first seven layers have a LeakyRelu activation function.

The mapping network 210 broadcasts the style vector 218 to every fully-connected layer in the NIIF 220 and at least one upsampling block 230(1 . . . n). For each such broadcast, there is an affine transformation layer (denoted by “A” in FIG. 2) that maps the style vector 218 to an affine-transformed style, which is used to modulate the feature maps of the NIIF 220 and the at least one upsampling block 230(1 . . . n).

The NIIF 220 is configured to take as input a 3D position and outputs a low-resolution albedo A(r), a low-resolution feature vector F(r), a low-resolution diffuse shading D(r), and a low-resolution specular shading S(r). The NIIF 220 includes a positional encoder 222, a six-layer MLP with 256 units, and a volume renderer 228. Each fully-connected layer has a leaky Relu activation function. The feature maps of each fully-connected layer are modulated by an affine transformation (“A”) from the mapping network 210.

At the fourth layer of the MLP there is an additional fully-connected layer at which the density α is output; the density is input into the volume renderer 228. The per-point feature vector f is output at the sixth fully-connected layer. There are two additional fully-connected layers after the MLP, at which the per-point albedo a and the blending weights co are output. The per-point albedo a and the blending weights co are also input into the volume renderer 228.

The volume renderer 228 performs the integrations according to Eq. (2) to produce the low-resolution albedo A(r), the low-resolution feature vector F(r), the low-resolution diffuse shading D(r), and the low-resolution specular shading S(r).

Each upsampling block 230(1 . . . n) (230(i), i=1, 2, . . . , n) includes two fully-connected layers of 256 units modulated by an affine transformation (“A”) of the style vector from the mapping network 210. Each upsampling block 230(i) also includes a PixelShuffler upsampler and a BlurPool with stride 1, which increases the resolution by 2x. The upsampling blocks 230(1 . . . n) take as input the low-resolution albedo A(r), the low-resolution feature vector F(r), the low-resolution diffuse shading D(r), and the low-resolution specular shading S(r) and produce, as outputs, a high-resolution feature vector, a high-resolution diffuse shading, and a high-resolution specular shading.

Each upsampling block 230(i) is also configured to upsample the low-resolution albedo to produce a high-resolution albedo. This is done by enforcing the first three channels of the high-resolution feature vector to correspond to the albedo image. The low-resolution albedo A(r) is used to enforce consistency with the high-resolution albedo. For the two shaping maps, bilinear upsampling is directly applied.

The relighting network 240 is configured to take as input the output of the set of upsampling blocks 230(1 . . . n) (e.g., the high-resolution albedo, high-resolution feature vector, the high-resolution diffuse shading, and the high-resolution specular shading) and produce a relit image 242. As shown in FIG. 2, the relighting network 240 is a U-Net with skip connections. That is, the relighting network 240 includes two ResBlocks of 64 units with a skip connection, two ResBlocks of 128 units with a skip connection, and a ResBlock of 256 units.

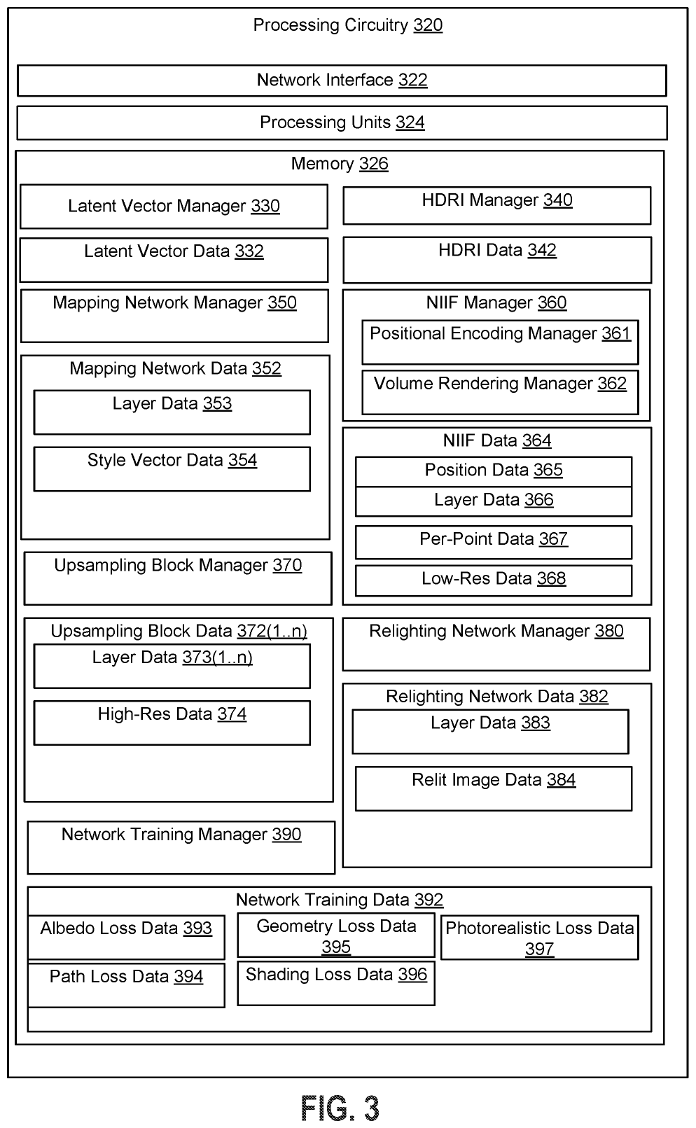

FIG. 3 is a diagram illustrating an example electronic environment for relighting images of synthetic human faces. The processing circuitry 320 includes a network interface 322, one or more processing units 324, and nontransitory memory (storage medium) 326.

In some implementations, one or more of the components of the processing circuitry 320 can be, or can include processors (e.g., processing units 324) configured to process instructions stored in the memory 326 as a computer program product. Examples of such instructions as depicted in FIG. 3 include latent vector manager 330, HDRI manager 340, mapping network manager 350, NIIF manager 360, upsampling block manager 370, relighting network manager 380, and network training manager 390. Further, as illustrated in FIG. 3, the memory 326 is configured to store various data, which is described with respect to the respective services and managers that use such data.

The latent vector manager 330 is configured to generate a random latent vector sampled from a Gaussian distribution to produce latent vector data 332. Latent vector data 332 is to be input into a mapping network (e.g., mapping network 210).

The HDRI manager 340 is configured to obtain or generate a HDRI map, represented by HDRI data 342. In some implementations, the HDRI manager 340 is configured to perform a preconvolution of an HDRI map with cosine lobe functions corresponding to a set of pre-selected Phong exponents to produce a set of light maps used in the volume rendering of the diffuse and specular shading.

The mapping network manager 350 is configured to generate, as mapping network data 352, a style vector (style vector data 354) representing a synthetic human face based on the latent vector data 332. The mapping network data 352 includes layer data 353 which represents a set of fully-connected layers and activation functions which convert the latent vector data 332 into style vector data 354. For example, as shown in FIG. 2, the layer data 353 represents, in some implementations, eight fully connected layers of 512 units each with he first seven having LeakyRelu activation functions.

The mapping network manager 350 is also configured to broadcast the style vector data 354 to affine transformation layers in the NIIF and upsampling blocks for modulating the feature maps in those networks.

The NIIF manager 360 is configured to produce a low-resolution albedo, a low-resolution feature vector, a low-resolution diffuse shading, and a low-resolution specular shading based on input from the style vector data 354 and position data 365 representing a 3D point. The NIIF manager 360 includes a positional encoding manager 361 and a volume rendering manager 362.

The positional encoding manager 261 is configured to encode a 3D position for input into the NIIF layers represented by layer data 366. In some implementations, the positional encoding manager 361 is configured to use a sinusoidal function based positional encoding to put the position data 365—representing a 3D position—in a form for input into the NIIF layers.

The NIIF manager 360 is configured to transform the encoded position into a per-point density, albedo, feature, and blending weights—e.g., per-point data 367—using the layer data 366. The layer data 366 represents a six-layer MLP with fully connected layers of 256 units each, along with a LeakyRelu activation function. Each layer uses an affine-transformed style vector to modulate the feature vector. There is an additional fully connected layer after the fourth layer, at which the density is output. The per-point feature vector is output after the sixth layer. The layer data 366 also includes two additional fully connected layers after the sixth layer, at which the per-point albedo and blending weights are output.

The volume rendering manager 362 is configured to apply the integrals in Eq. (2) to the per-point data 367 to produce low-resolution data 368, e.g., low-resolution albedo A(r), the low-resolution feature vector F(r), the low-resolution diffuse shading D(r), and the low-resolution specular shading S(r). The low-resolution data 368 is then input for the upsampling blocks.

The upsampling block manager 370 is configured to convert a low-resolution image (e.g., 64×64), e.g., low-resolution data 368, to a high-resolution image (e.g., 128×128 or 256×256), e.g., high-resolution data 374, using an upsampling network, represented by upsampling block data 372(1 . . . n). The upsampling block data 372(1 . . . n) includes n blocks, each of which has respective layer data, e.g., 373(i), i=1, 2, . . . , n. The layer data 373(i) for the ith block includes two fully connected layers of 256 units each and a third layer that includes a PixelShuffle and BlurPool with stride 1, which increases resolution by a factor of two. The two fully connected layers also use the affine-transformed style vector to modulate the feature vector.

The high-resolution data 374 includes a high-resolution feature vector, a high-resolution diffuse shading, and a high-resolution specular shading. Moreover, by constraining the feature vector, the upsampling block manager 370 is also configured to produce a high-resolution albedo as part of the high-resolution data 374. The upsampling block manager 370 is also configured to input the high-resolution data 374 into the relighting network.

The relighting network manager 380 is configured to produce relit image data 384 representing a 3D relit image of a synthetic human face represented by style vector data 354 and based on the high-resolution data 374 output by the upsampling block manager 370. The righting network manager 380 operates the relighting network, represented by layer data 383 in relighting network data 382. The layer data 383 represents the architecture of the relighting network, which is a shallow U-net with skip connections.

The network training manager 390 is configured to perform training operations on the Volux-GAN represented by mapping network manager 350, NIIF manager 360, upsampling block manager 370, and relighting network manager 380. The network training manager is configured to, for each image in a training set, randomly select a HDRI map and perform a rotation on the HDRI map. A state-of-the-art relighting algorithm (e.g., Total Relighting) is run to determine pseudo-ground truth albedo and normals. The training is supervised using loss functions determined from the low- and high-resolution data 368 and 374. As shown in FIG. 3, the network training data 392 includes albedo adversarial loss data 393, path loss data 394, geometry adversarial loss data 395, shading adversarial loss data 396, and photorealistic adversarial loss data 397.

The components (e.g., modules, processing units 324) of processing circuitry 320 can be configured to operate based on one or more platforms (e.g., one or more similar or different platforms) that can include one or more types of hardware, software, firmware, operating systems, runtime libraries, and/or so forth. In some implementations, the components of the processing circuitry 320 can be configured to operate within a cluster of devices (e.g., a server farm). In such an implementation, the functionality and processing of the components of the processing circuitry 320 can be distributed to several devices of the cluster of devices.

The components of the processing circuitry 320 can be, or can include, any type of hardware and/or software configured to process private data from a wearable device in a split-compute architecture. In some implementations, one or more portions of the components shown in the components of the processing circuitry 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 320 can be, or can include, a software module configured for execution by at least one processor (not shown) to cause the processor to perform a method as disclosed herein. In some implementations, the functionality of the components can be included in different modules and/or different components than those shown in FIG. 3, including combining functionality illustrated as two components into a single component.

The network interface 322 includes, for example, wireless adaptors, and the like, for converting electronic and/or optical signals received from the network to electronic form for use by the processing circuitry 320. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form processing circuitry, which is configured and arranged to carry out various methods and functions as described herein.

Although not shown, in some implementations, the components of the processing circuitry 320 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 320 can be, or can include, processors configured to process instructions stored in a memory. For example, latent vector manager 330 (and/or a portion thereof), HDRI manager 340 (and/or a portion thereof), mapping network manager 350 (and/or a portion thereof), NIIF manager 360 (and/or a portion thereof), upsampling block manager 370 (and/or a portion thereof), relighting network manager 380 (and/or a portion thereof), and network training manager (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 320. As illustrated in FIG. 3, the memory 326 is configured to store various data, including latent vector data 332, HDRI data 342, mapping network data 352, NIIF data 364, upsampling block data 372(1, . . . n), relighting network data 382, and network training data 392.

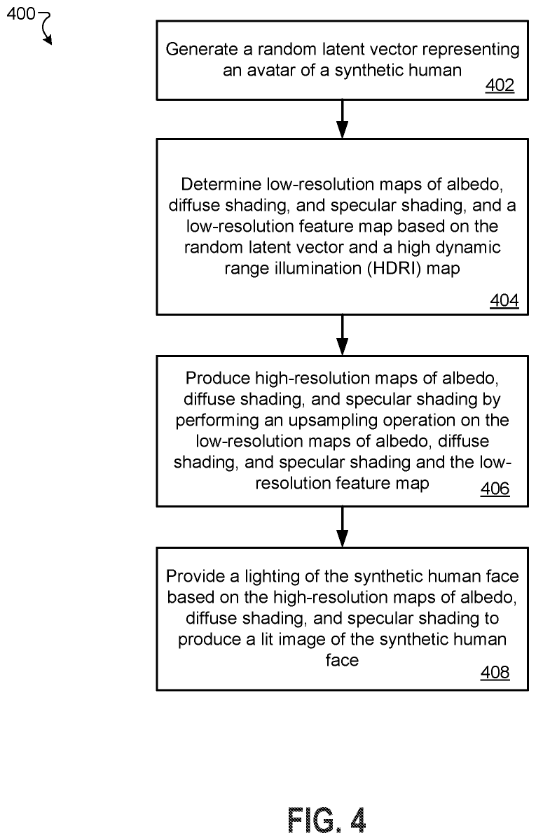

FIG. 4 is a flow chart illustrating an example method 400 for relighting a synthetic human face. The method 400 may be performed using the processing circuitry 320 of FIG. 3.

At 402, the latent vector manager 330 generates a random latent vector representing an avatar of a synthetic human face.

At 404, the NIIF manager 360 determines low-resolution maps of albedo, diffuse shading, and specular shading, and a low-resolution feature map based on the random latent vector and a high dynamic range illumination (HDRI) map.

At 406, the upsampling block manager 370 produces high-resolution maps of albedo, diffuse shading, and specular shading by performing an upsampling operation on the low-resolution maps of albedo, diffuse shading, and specular shading and the low-resolution feature map.

At 408, the relighting network manager 380 provides a lighting of the synthetic human face based on the high-resolution maps of albedo, diffuse shading, and specular shading to produce a lit image of the synthetic human face.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method, comprising:
generating a random latent vector representing an avatar of a synthetic human face;
determining low-resolution maps of albedo, diffuse shading, and specular shading, and a low-resolution feature map based on the random latent vector and a high dynamic range illumination (HDRI) map;
producing high-resolution maps of albedo, diffuse shading, and specular shading by performing an upsampling operation on the low-resolution maps of albedo, diffuse shading, and specular shading and the low-resolution feature map; and
providing a lighting of the synthetic human face based on the high-resolution maps of albedo, diffuse shading, and specular shading to produce a lit image of the synthetic human face.

2. The method as in claim 1, wherein determining the low-resolution maps includes:
inputting the random latent vector into a mapping network to produce a style vector;
inputting the style vector into at least one fully connected layer of a neural implicit intrinsic field (NIIF) which, upon an input of a positional encoding, is configured to produce a per-point albedo, per-point density, and per-point reflectance properties at the at least one fully connected layer of the NIIF;
inputting the positional encoding into the NIIF; and
performing a volumetric rendering of the per-point albedo and per-point reflectance properties based on the per-point density to produce the low-resolution maps of albedo, diffuse shading, and specular shading.

3. The method as in claim 2, further comprising:
preconvolving the HDRI map with cosine lobe functions corresponding to a plurality of pre-selected Phong specular exponents to produce a plurality of light maps, each of the plurality of light maps corresponding to a respective Phong specular exponent of the plurality of pre-selected Phong specular exponents.

4. The method as in claim 3, wherein performing the volumetric rendering of the per-point reflectance properties includes:
associating a per-point diffuse shading with a first light map of the plurality of light maps; and
integrating the per-point diffuse shading along a ray of the HDRI map to produce the low-resolution map of diffuse shading.

5. The method as in claim 3, wherein the per-point reflectance properties include a set of blending weights, and
wherein performing the volumetric rendering of the per-point reflectance properties includes:
associating a per-point specular shading to a linear combination of the plurality of light maps, the linear combination being formed using the set of blending weights.

6. The method as in claim 2, wherein the per-point albedo is restricted to be view and lighting independent.

7. The method as in claim 2, wherein the mapping network, the NIIF, an upsampling network configured to perform the upsampling operation, and a relighting network configured to provide the lighting of the synthetic human face are, in this order, included in a generative adversarial network (GAN) configured to provide the lighting of the synthetic human face given the random latent vector and the HDRI map.

8. The method as in claim 7, wherein the GAN is trained using a pseudo ground truth albedo, a pseudo ground truth normal, and an adversarial loss function.

9. The method as in claim 8, wherein the adversarial loss function includes an albedo adversarial loss which depends on the low-resolution map of albedo and the high-resolution map of albedo.

10. The method as in claim 8, wherein the adversarial loss function includes a geometry adversarial loss which depends on a gradient of the per-point density.

11. The method as in claim 8, wherein the adversarial loss function includes a shading adversarial loss which depends on the low-resolution map of diffuse shading, the low-resolution map of specular shading, and the lit image of the synthetic human face.

12. The method as in claim 8, wherein the adversarial loss function includes a photorealistic adversarial loss which depends on the lit image of the synthetic human face.

13. The method as in claim 8, wherein the adversarial loss function includes a path loss which depends on the low-resolution map of albedo and the high-resolution map of albedo.

14. A computer program product comprising a nontransitory storage medium, the computer program product including code that, when executed by processing circuitry, causes the processing circuitry to perform a method, the method comprising:
generating a random latent vector representing an avatar of a synthetic human face;
determining low-resolution maps of albedo, diffuse shading, and specular shading, and a low-resolution feature map based on the random latent vector and a high dynamic range illumination (HDRI) map;
producing high-resolution maps of albedo, diffuse shading, and specular shading by performing an upsampling operation on the low-resolution maps of albedo, diffuse shading, and specular shading and the low-resolution feature map; and
providing a lighting of the synthetic human face based on the high-resolution maps of albedo, diffuse shading, and specular shading to produce a lit image of the synthetic human face.

15. The computer program product as in claim 14, wherein determining the low-resolution maps includes:
inputting the random latent vector into a mapping network to produce a style vector;
inputting the style vector into at least one fully connected layer of a neural implicit intrinsic field (NIIF) which, upon an input of a positional encoding, is configured to produce a per-point albedo, per-point density, and per-point reflectance properties at the at least one fully connected layer of the NIIF;
inputting the positional encoding into the NIIF; and
performing a volumetric rendering of the per-point albedo and per-point reflectance properties based on the per-point density to produce the low-resolution maps of albedo, diffuse shading, and specular shading.

16. The computer program product as in claim 15, wherein the method further comprises:
preconvolving the HDRI map with cosine lobe functions corresponding to a plurality of pre-selected Phong specular exponents to produce a plurality of light maps, each of the plurality of light maps corresponding to a respective Phong specular exponent of the plurality of pre-selected Phong specular exponents.

17. The computer program product as in claim 16, wherein performing the volumetric rendering of the per-point reflectance properties includes:
associating a per-point diffuse shading to a first light map of the plurality of light maps; and
integrating the per-point diffuse shading along a ray of the HDRI map to produce the low-resolution map of diffuse shading.

18. An electronic apparatus, the electronic apparatus comprising:
memory; and
processing circuitry coupled to the memory, the processing circuitry being configured to:
generate a random latent vector representing an avatar of a synthetic human face;
determine low-resolution maps of albedo, diffuse shading, and specular shading, and a low-resolution feature map based on the random latent vector and a high dynamic range illumination (HDRI) map;
produce high-resolution maps of albedo, diffuse shading, and specular shading by performing an upsampling operation on the low-resolution maps of albedo, diffuse shading, and specular shading and the low-resolution feature map; and
provide a lighting of the synthetic human face based on the high-resolution maps of albedo, diffuse shading, and specular shading to produce a lit image of the synthetic human face.

19. The electronic apparatus as in claim 18, wherein the processing circuitry configured to determine the low-resolution maps is further configured to:
input the random latent vector into a mapping network to produce a style vector;
input the style vector into at least one fully connected layer of a neural implicit intrinsic field (NIIF) which, upon an input of a positional encoding, is configured to produce a per-point albedo, per-point density, and per-point reflectance properties at the at least one fully connected layer of the NIIF;
input the positional encoding into the NIIF; and
perform a volumetric rendering of the per-point albedo and per-point reflectance properties based on the per-point density to produce the low-resolution maps of albedo, diffuse shading, and specular shading.

20. The electronic apparatus as in claim 19, wherein the processing circuitry is further configured to:
preconvolve the HDRI map with cosine lobe functions corresponding to a plurality of pre-selected Phong specular exponents to produce a plurality of light maps, each of the plurality of light maps corresponding to a respective Phong specular exponent of the plurality of pre-selected Phong specular exponents.
